(19) United States
(12) Patent Application Publication
(10) Pub. No.: US 2025/0021883 A1
(43) Pub. Date: Jan. 16, 2025

(54) METHOD FOR TRAINING LANGUAGE MODEL, DEVICE FOR EMOTION DIAGNOSIS USING PRE-TRAINED LANGUAGE MODEL, AND STORAGE MEDIUM STORING INSTRUCTIONS TO PERFORM METHOD FOR TRAINING LANGUAGE MODEL

(71) Applicant: Research & Business Foundation SUNGKYUNKWAN UNIVERSITY, Suwon-si (KR)

(72) Inventors: Ha Young OH, Suwon-si (KR); Jae Dong OH, Suwon-si (KR)

(73) Assignee: Research & Business Foundation SUNGKYUNKWAN UNIVERSITY, Suwon-si (KR)

(21) Appl. No.: 18/772,427

(22) Filed: Jul. 15, 2024

(30) Foreign Application Priority Data
Jul. 14, 2023 (KR) 10-2023-0091935

(51) Int. Cl. G06N 20/00; G06F 40/35

(52) U.S. Cl. CPC G06N 20/00; G06F 40/35

(57) ABSTRACT

There is provided a method for training text-based emotion detection language model. The method comprises receiving text data; generating clean data by removing errors included in the received text data; detecting emotion data related to a specific emotion from the clean data and generating a training dataset including the detected emotion data; and training the language model using the training dataset.

### CROSS-REFERENCE TO RELATED APPLICATION

This application claims priority to Korean Patent Application No. 10-2023-0091935, filed on Jul. 14, 2023 in the Korean Intellectual Property Office, the entire disclosures of which are incorporated herein by reference for all purposes.

### TECHNICAL FIELD

The present disclosure relates to a text-based emotion detection language model training method, a language model training device, and an emotion diagnosis device using the same.

### BACKGROUND

Currently, various prior studies are being conducted in the field of natural language processing to detect emotions related to depression.

For example, there are methods of predicting users who are susceptible to depression by analyzing social media, and methods of making a binary classification of whether a user is depressed or not, or classifying depression with a larger category of other diseases-dementia, anxiety, and psychosis.

Meanwhile, in order to determine the level of depression of a user, research is being conducted to estimate the level of depression as low, medium, or high using the Hamilton Rating Scale for Depression (HRSD).

When predicting users vulnerable to depression by analyzing social media, it is difficult to use real-time conversation services such as Chatbot because status information of users is required.

In addition, even in the case of research to determine the degree of depression using the Hamilton Depression Rating Scale, it is difficult to apply real-time services such as Chatbot because the degree of depression needs to be determined through a survey.

In addition, in the case of previous depression classification studies, the nine symptoms for diagnosing depression that appear in Major Depressive Episode (MDD) of DSM-5 defined by the American Psychiatric Association (APA) are not classified, and thus it is difficult to immediately determine what symptoms a user is experiencing.

### SUMMARY

Objects of embodiments of the present disclosure include analyzing user input text to determine in detail which symptoms of MDD a user is currently experiencing and predicting the intensity of depression with a score.

Further, a purpose of the present invention is to provide a technology for extracting rendering points based on joint information that constitutes the character's motion depending on skeleton data for the character and transmitting haptics to a user based on the rendering points.

In accordance with an aspect of the present disclosure, there is provided a method for training language model performed by a device for training language model, the method comprises: receiving text data; generating clean data by removing errors included in the received text data; detecting emotion data related to a specific emotion from the clean data and generating a training dataset including the detected emotion data; and training the language model using the training dataset.

The language model may include a first language model for calculating an intensity of emotion with respect to the specific emotion; and a second language model for performing detailed emotion classification with respect to the specific emotion.

The generating clean data may include removing missing values from the text data; and removing errors from the text data by performing a referential integrity check on data from which the missing values have been removed.

The training dataset may include a first training dataset including a collection of overall rankings of respondents; and a second training dataset including emotion diagnosis information.

The generating the first training dataset may include extracting data including keywords related to the specific emotion from the clean data; and obtaining data related to symptoms related to the specific emotion as emotion data from the extracted data.

The generating the first training dataset may include extracting data including keywords and negative words related to the specific emotion from the clean data and obtaining the data as daily data.

The method further comprises, after the generating the first training dataset, matching predetermined annotation information to the emotion data based on classification conditions preset for the the first training dataset.

The generating the second training dataset may include extracting similar data including similar words from the clean data based on preset base words related to the specific emotion; and obtaining the similar data and daily data as emotion data.

In accordance with another aspect of the present disclosure, there is provided a device for training language model, the device comprises: a memory configured to store one or more instructions; and a processor configured to execute the one or more instructions stored in the memory, wherein the instructions, when executed by the processor, cause the processor to: receiving text data; generating clean data by removing errors included in the received text data; detecting emotion data related to a specific emotion from the clean data and generating a training dataset including the detected emotion data; and training the language model using the training dataset.

The language model may include a first language model for calculating an intensity of emotion with respect to the specific emotion; and a second language model for performing detailed emotion classification with respect to the specific emotion.

The generating clean data may include removing missing values from the text data; and removing errors from the text data by performing a referential integrity check on data from which the missing values have been removed.

The training dataset may include a first training dataset including a collection of overall rankings of respondents; and a second training dataset including emotion diagnosis information.

The generating the first training dataset may include extracting data including keywords related to the specific emotion from the clean data; and obtaining data related to symptoms related to the specific emotion as emotion data from the extracted data.

The generating the first training dataset may include extracting data including keywords and negative words related to the specific emotion from the clean data and obtaining the data as daily data.

The method further comprises, after the generating the first training dataset, matching predetermined annotation information to the emotion data based on classification conditions preset for the the first training dataset.

The generating the second training dataset may include extracting similar data including similar words from the clean data based on preset base words related to the specific emotion; and obtaining the similar data and daily data as emotion data.

In accordance with another aspect of the present disclosure, there is provided a device for emotion diagnosis, the device comprises: a memory configured to store a pre-trained language model and one or more instructions for executing the pre-trained language model; and a processor configured to execute the one or more instructions stored in the memory, wherein the instructions, when executed by the processor, cause the processor to: receive text data for diagnosing an emotion, and output an intensity of emotion and classified detailed emotions with respect to a specific emotion from the text data using the language model, wherein the pre-trained language model has been trained using a training dataset on emotion data related to the specific emotion.

The pre-trained language model may include a first language model for calculating an intensity of emotion with respect to the specific emotion; and a second language model for performing detailed emotion classification with respect to the specific emotion.

The training dataset may include a first training dataset including a collection of overall rankings of respondents; and a second training dataset including emotion diagnosis information.

In accordance with another aspect of the present disclosure, there is provided a device for emotion diagnosis, the device comprises: a memory configured to store a pre-trained language model and one or more instructions for executing the pre-trained language model; and a processor configured to execute the one or more instructions stored in the memory, wherein the instructions, when executed by the processor, cause the processor to: receive text data for diagnosing an emotion, and output an intensity of emotion and classified detailed emotions with respect to a specific emotion from the text data using the language model, wherein the pre-trained language model has been trained using a training dataset on emotion data related to the specific emotion.

In accordance with another aspect of the present disclosure, there is provided a non-transitory computer readable storage medium storing computer program including computer executable instructions, wherein the instructions, when executed by a processor, cause the processor to perform a method for training language model pe, the method comprises: receiving text data; generating clean data by removing errors included in the received text data; detecting emotion data related to a specific emotion from the clean data and generating a training dataset including the detected emotion data; and training the language model using the training dataset.

In accordance with another aspect of the present disclosure, there is provided computer program including computer executable instructions stored in a non-transitory computer readable storage medium, wherein the instructions, when executed by a processor, cause the processor to perform a method for training language model pe, the method comprises: receiving text data; generating clean data by removing errors included in the received text data; detecting emotion data related to a specific emotion from the clean data and generating a training dataset including the detected emotion data; and training the language model using the training dataset. As described above, according to embodiments of the present disclosure, it is possible to analyze user input text to determine in detail which symptoms of MDD a user is currently experiencing and predict the intensity of depression with a score, thereby analyzing the cause of emotions of the user in detail.

Even if effects are not explicitly mentioned here, the effects described in the following specification and potential effects expected by the technical features of the present disclosure are treated as if described in the specification of the present disclosure.

### BRIEF DESCRIPTION OF THE DRAWINGS

FIG. 1 is a block diagram showing an emotion diagnosis device according to an embodiment of the present disclosure.

FIG. 2 is a flowchart showing a language model training method according to an embodiment of the present disclosure.

FIG. 3 is a diagram showing a language model training device 1 according to an embodiment of the present disclosure.

FIG. 4 is a diagram showing the curation module of the language model training device according to an embodiment of the present disclosure.

FIG. 5 is a flowchart showing steps of constructing the first training dataset in the language model training method according to an embodiment of the present disclosure.

FIG. 6 and FIG. 7 are diagrams showing the first training data construction module of the language model training device according to an embodiment of the present disclosure.

FIG. 8 and FIG. 9 are diagrams for describing the step of annotating emotion data in the language model training method according to an embodiment of the present disclosure.

FIG. 10 is a flowchart showing the step of constructing the second training dataset in the language model training method according to an embodiment of the present disclosure.

FIG. 11 is a diagram showing the second training data construction module of the language model training device according to an embodiment of the present disclosure.

FIG. 12 to FIG. 15 are diagrams for describing DSM-5 datasets used in the language model training method according to an embodiment of the present disclosure.

FIG. 16A, FIG. 16B, FIG. 17, FIG. 18A, FIG. 18B, and FIG. 18C are diagrams showing examples of diagnosis results of the emotion diagnosis device according to an embodiment of the present disclosure.

### DETAILED DESCRIPTION

The advantages and features of the embodiments and the methods of accomplishing the embodiments will be clearly understood from the following description taken in conjunction with the accompanying drawings. However, embodiments are not limited to those embodiments described, as embodiments may be implemented in various forms. It should be noted that the present embodiments are provided to make a full disclosure and also to allow those skilled in the art to know the full range of the embodiments. Therefore, the embodiments are to be defined only by the scope of the appended claims.

Terms used in the present specification will be briefly described, and the present disclosure will be described in detail.

In terms used in the present disclosure, general terms currently as widely used as possible while considering functions in the present disclosure are used. However, the terms may vary according to the intention or precedent of a technician working in the field, the emergence of new technologies, and the like. In addition, in certain cases, there are terms arbitrarily selected by the applicant, and in this case, the meaning of the terms will be described in detail in the description of the corresponding invention. Therefore, the terms used in the present disclosure should be defined based on the meaning of the terms and the overall contents of the present disclosure, not just the name of the terms.

When it is described that a part in the overall specification “includes” a certain component, this means that other components may be further included instead of excluding other components unless specifically stated to the contrary.

In addition, a term such as a “unit” or a “portion” used in the specification means a software component or a hardware component such as FPGA or ASIC, and the “unit” or the “portion” performs a certain role. However, the “unit” or the “portion” is not limited to software or hardware. The “portion” or the “unit” may be configured to be in an addressable storage medium, or may be configured to reproduce one or more processors. Thus, as an example, the “unit” or the “portion” includes components (such as software components, object-oriented software components, class components, and task components), processes, functions, properties, procedures, subroutines, segments of program code, drivers, firmware, microcode, circuits, data, database, data structures, tables, arrays, and variables. The functions provided in the components and “unit” may be combined into a smaller number of components and “units” or may be further divided into additional components and “units”.

Hereinafter, the embodiment of the present disclosure will be described in detail with reference to the accompanying drawings so that those of ordinary skill in the art may easily implement the present disclosure. In the drawings, portions not related to the description are omitted in order to clearly describe the present disclosure.

The terms such as ‘ . . . unit’ and ‘ . . . group’ as used below refer to a unit that processes at least one function or motion, and may be implemented as a hardware, a software, or a combination of the hardware and the software.

The present disclosure relates to a text-based emotion detection language model training method, a language model training device, and an emotion diagnosis device using the same.

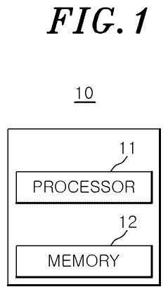

FIG. 1 is a block diagram showing an emotion diagnosis device according to an embodiment of the present disclosure.

Referring to FIG. 1, the emotion diagnosis device 10 according to an embodiment of the present disclosure includes a processor 11 and a memory 12.

The emotion diagnosis device 10 according to an embodiment of the present disclosure is a device for analyzing the cause of a user's emotion in detail using a pre-trained language model.

Specifically, when a user inputs text, it is possible to determine in detail which symptoms of MDD the user is currently experiencing by analyzing the user input text and predict the intensity of depression with a score.

In an embodiment of the present disclosure, a score between 0 and 16 may be assigned, but the present disclosure is not limited thereto.

Accordingly, it is possible to detect depressive symptoms early and track the depressive state such that the user can recognize his or her condition without visiting a hospital.

The processor 11 according to an embodiment of the present disclosure may execute one or more instructions stored in the memory 12, which will be described later.

Specifically, arbitrary text data for diagnosing emotions may be received, and the intensity of emotion and classified detailed emotions with respect to a specific emotion may be output from the text data using a language model.

A language model according to an embodiment of the present disclosure may be trained using a training dataset regarding emotion data related to a specific emotion.

In various embodiments of the present disclosure, the specific emotion may be “depression”. However, language model training and emotion diagnosis may be performed based on various emotions.

The language model may include a first language model that calculates the intensity of emotion with respect to a specific emotion and a second language model that performs detailed emotion classification with respect to the specific emotion.

Additionally, the training dataset may include a first training dataset including a collection of overall rankings of respondents and a second training dataset including emotion diagnosis information.

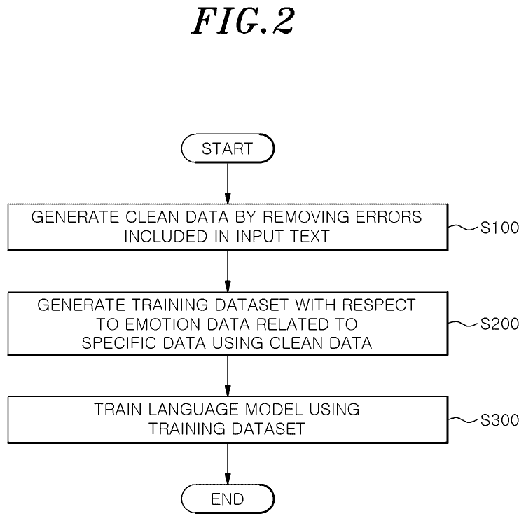

A method and device for training a language model according to an embodiment of the present disclosure will be described in detail with reference to FIG. 2 to FIG. 15 below.

According to one embodiment of the present disclosure, the processor 11 may be divided into a plurality of modules according to functions, or functions may be executed by one processor.

Additionally, the processor 11 may be configured to process instructions of a computer program by performing basic arithmetic, logic, and input/output operations. Instructions may be provided to the processor 11 through the memory 12 or a communication module. For example, the processor 11 may be configured to execute received instructions according to program code stored in a recording device such as the memory 12.

The memory 12 may store programs (one or more instructions) for processing and control of the processor 11 and may store a pre-trained language model.

The memory 12 is a computer-readable recording medium and may include a permanent mass storage device such as a random access memory (RAM), a read only memory (ROM), and a disk drive. Additionally, an operating system and at least one program code may be stored in the memory 12. Such software components may be loaded from a computer-readable recording medium separate from the memory 12 using a drive mechanism. Such separate computer-readable recording media may include computer-readable recording media such as floppy drives, disks, tapes, DVD/CD-ROM drives, and memory cards. In another embodiment, software components may be loaded into the memory 12 through a communication module rather than a computer-readable recording medium. For example, at least one program may be loaded into in the memory 12 based on a program (e.g., the above-described application) installed by files provided over a network by developers or a file distribution system that distributes an application installation file.

FIG. 2 is a flowchart showing a language model training method according to an embodiment of the present disclosure.

Referring to FIG. 2, the language model training method according to an embodiment of the present disclosure is performed by a language model training device which will be described later, and the language model training device curates text data input in step S100 into clean data for language model training.

Here, the step of curating into clean data (S100) may include a step of removing missing values from the text data and performing referential integrity check.

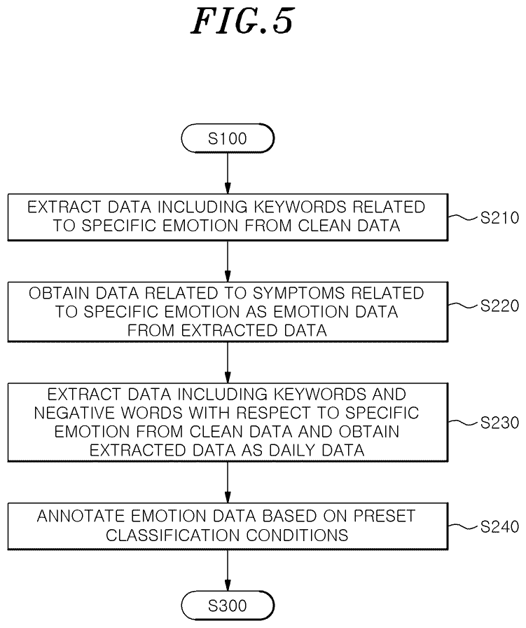

This will be described in detail with reference to FIG. 4 below.

Thereafter, a training dataset on emotion data related to a specific emotion is constructed using the clean data in step S200, and the language model is trained using the training dataset in step S300.

The language model may include a first language model that calculates the intensity of emotion with respect to a specific emotion and a second language model that performs detailed emotion classification with respect to a specific emotion.

Here, the first language model may be the Bert BWS model, and the Bert BWS model may calculate a depression intensity for user input utterances.

The second language model may be the DSM-5 model, and the DSM-5 model may perform detailed depressive emotion classification on user input utterances.

According to an embodiment of the present disclosure, it is possible to predict the cause of a user's emotion by performing detailed emotion classification.

For example, it is possible to predict the cause of whether a user is depressed because they feel helpless or because they cannot sleep much, among depressive emotions.

Additionally, the training dataset may include a first training dataset including a collection of overall rankings of respondents and a second training dataset including emotion diagnosis information.

Here, the first training data may be best-worst scaling (BWS) data, and the second training data may be DSM-5 data.

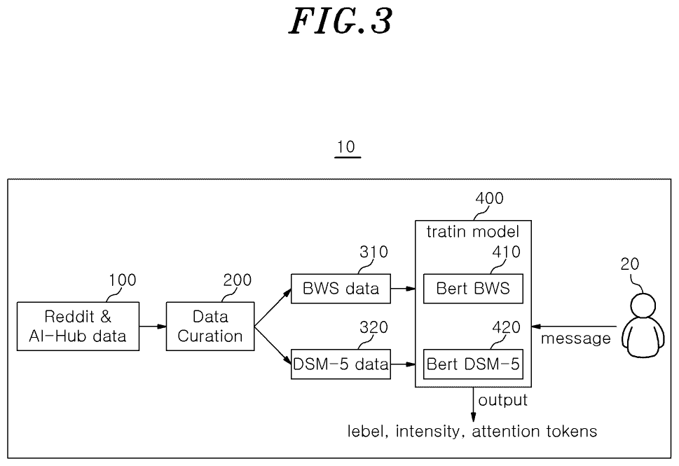

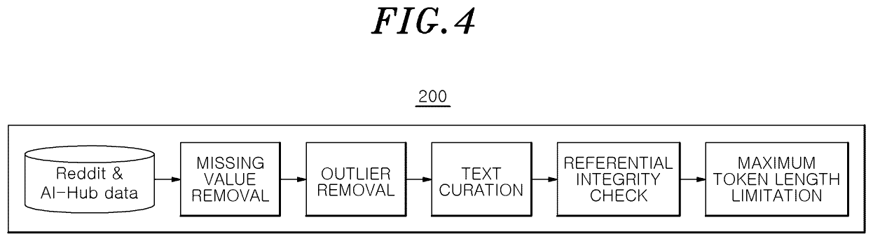

FIG. 3 is a diagram showing a language model training device 1 according to an embodiment of the present disclosure.

Referring to FIG. 3, the language model training device 1 according to an embodiment of the present disclosure may include a collection module 100, a curation module 200, and training data construction modules 310 and 320.

The language model training device 1 according to an embodiment of the present disclosure is a device for training a language model 400.

Specifically, it refers to a model architecture that analyzes user utterance text to explain how much depressed emotions the user is feeling, what kind of depressive emotions the user is feeling in detail, and what is the basis for this analysis.

The collection module 100 includes Reddit Archive and AI-Hub, and may receive text data for training the language model 400.

For example, as data used to analyze the intensity of depressive emotions input as text data and classify detailed emotions related to depression, posts and comments posted on the subreddit depression (‘r/depression’) from 2010 to 2016 may be used, and the data may be collected from the Reddit Archive.

Here, the posting period is not limited and may be changed by a person skilled in the art.

The curation module 200 may curate input text data into clean data for training a language model.

The curation module 200 may remove missing values, limit a token length, remove data written in languages other than English, curate text, and de-identify personal information for collected data.

This will be described in detail with reference to FIG. 4 below.

The training data construction modules 310 and 320 may construct a training dataset regarding emotion data related to a specific emotion using the clean data.

In various embodiments of the present disclosure, a specific emotion may be “depression”. However, language model training and emotion diagnosis can be performed based on various emotions.

The training data construction modules may include a first training data construction module 310 and a second training data construction module 320.

Here, the first training data may be best-worst scaling (BWS) data, and the second training data may be DSM-5 data.

Accordingly, the training data construction modules 310 and 320 may use BWS and DSM-5 data constructed through curation of data collected from the Reddit Archive and AI-Hub to train a language model.

The first training data construction module 310 may construct the first training dataset including a collection of overall rankings of respondents.

The second training data construction module 320 may construct the second training dataset including emotion diagnosis information.

The language model 400 is trained using the constructed training datasets.

Here, the language model 400 may include a first language model 410 that calculates the intensity of emotion with respect to the specific emotion and a second language model 420 that performs detailed emotion classification with respect to the specific emotion.

The language model 400 used for learning each task is bidirectional encoder representations transformers (BERT).

Here, the first language model 410 may be a Bert BWS model, and the Bert BWS model may calculate depression intensity for user input utterances.

Previously constructed BWS data is converted into the input format of the BERT model and then the model is trained. The model is trained to minimize root-mean-square error values, and during training, a batch size may be set to 8 and a learning rate may be set to 5e-05.

The second language model 410 may be a DSM-5 model, and the DSM-5 model may perform detailed depressive emotion classification on user input utterances.

Previously constructed DSM-5 data is converted into the input format of the BERT model and the model is trained. The model is trained to minimize categorical cross entropy loss values, and during training, a batch size may be set to 8 and a learning rate may be set to 5e-05.

In addition, to improve the prediction rate of the model, it is possible to perform training using various models such as tiny and small models in addition to the Bert-Base model.

The language model 400 trained by the language model training device 1 may finally receive text from the emotion diagnosis device 10 described in FIG. 1 and return depression-related symptoms, depression intensity, and attention tokens.

Specifically, tokens with high scores may be returned together based on an attention score to explain classification results of the model.

In order to calculate an attention score and analyze output results of the model, all weight values of attention heads in the last hidden layer of the DSM-5 model are added and converted to a one-dimensional array.

Tokens with high attention weights among tokens excluding [CLS], [September], ‘.’, and ‘,’ tokens are sequentially returned using the values, and the number of tokens returned is set to not exceed half of the input text.

For example, text such as “I am depressed” may be finally received and depression-related symptoms, depression intensity, and attention tokens may be returned.

According to various embodiments of the present disclosure, the emotion diagnosis device 10 may be included in the language model training device 1 or may be configured separately sharing only the language model.

The BWS model returns the intensity of depression for input user utterances, and the DSM-5 model returns detailed depressive emotions for the input user utterances. Accordingly, tokens with high scores based on attention scores are also returned, and thus it is possible to understand which token the model classified detailed depressive emotions based on.

FIG. 4 is a diagram showing the curation module of the language model training device according to an embodiment of the present disclosure.

Referring to FIG. 4, the curation module 200 may curate input text data into clean data for training a language model.

Specifically, the data curation process will be described. First, missing values such as ‘ ’ and ‘[deleted]’ are removed from collected data.

Thereafter, outliers that include duplicate cross-postings on other subreddits or links leading to other sites are removed.

Text curation is performed to remove unnecessary special characters, etc., and referential integrity check is performed to determine whether comments without posts are present to remove data that violates the same.

Lastly, the maximum token length per text is limited to 32 and data that is too long is removed.

FIG. 5 is a flowchart showing steps of constructing the first training dataset in the language model training method according to an embodiment of the present disclosure.

Referring to FIG. 5, step S200 of constructing the first training dataset may be performed in a first training data construction module, and the first training data construction module may extract data including keywords regarding the specific emotion from the clean data in step S210.

In step S220, data related to symptoms related to the specific emotion are obtained as emotion data from the extracted data.

Thereafter, in step S230, data containing the keywords and negative words related to the specific emotion is extracted from the clean data and obtained as daily data.

The emotion data is annotated based on classification conditions preset for the the first training dataset constructed in step S240.

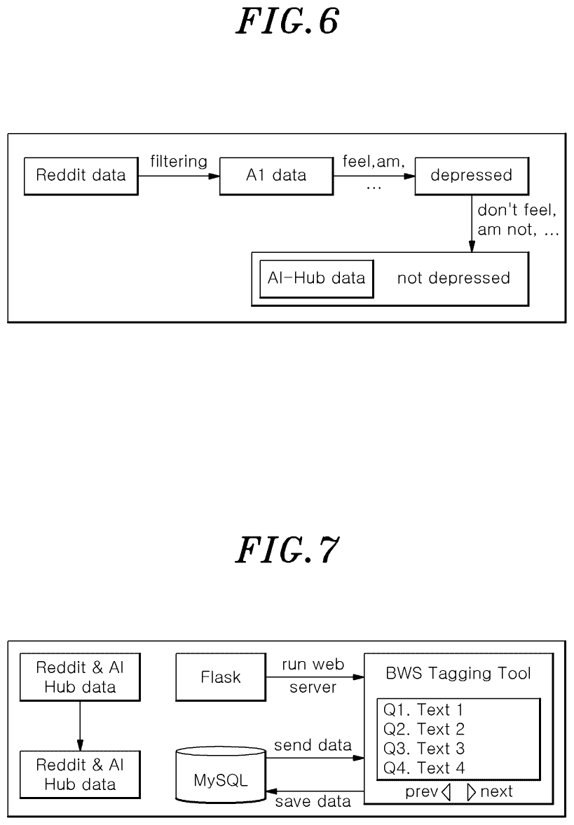

FIG. 6 and FIG. 7 are diagrams showing the first training data construction module of the language model training device according to an embodiment of the present disclosure.

Referring to FIG. 6, the first training data construction module may extract data containing keywords related to the specific emotion from the clean data and obtain, as emotion data, data related to symptoms related to the specific emotion from the extracted data.

Specifically, a process of constructing a best-worst scaling dataset is described with reference to FIG. 6.

First, data containing words related to depression (AI data) are extracted from data on which data curation has been performed, and data related to depressive symptoms of DSM-5 Major Depressive Episode is constructed.

Meanwhile, words such as “I am not depressed” are converted into a non-depressed dataset through additional operation. The dataset (non-depressed) may include subject-specific daily conversation data from AI-Hub.

Referring to FIG. 7, the first training data construction module may annotate the emotion data based on classification conditions preset for the constructed first training dataset.

Specifically, the process of annotation using the BWS dataset constructed through FIG. 7 will be described.

The constructed BWS dataset is stored in MySQL, and by running a web page with Flask, an environment in which data stored in MySQL can be annotated is created. The results of annotation are stored in MySQL in real time, and this process may be performed for a total of 8 annotation operation sets.

For example, to predict depression intensity from user input text, data for BWS annotation is constructed using collected Reddit data. Best-worst scaling is a technique for selecting the best and worst items among n given items (where n=4). In one embodiment of the present disclosure, among four pieces of text, the text with the highest depression intensity and the text with the lowest depression intensity may be annotated.

To perform annotation operation, Flask, MySQL, and Bootstrap may be used, and annotation may be performed on web pages.

The first training data construction module uses an annotation tool to construct a best-worst scaling dataset, and each piece of data has a depressive emotion intensity value between −1 and 1 point (−1: not depressed, 1: extremely depressed). Then, the depression intensity between-1 and 1 points may be linearly converted to values between 0 and 16 points and used for model training.

Depressed among detailed symptoms, and some data corresponding to a daily label are extracted and best-worst scaling (BWS) annotation is performed thereon to obtain text data and BWS data labeled with depression intensity.

Thereafter, for each piece of obtained data, the model is trained using a language model, and each model is trained to minimize a loss function value used in regression and classification problems.

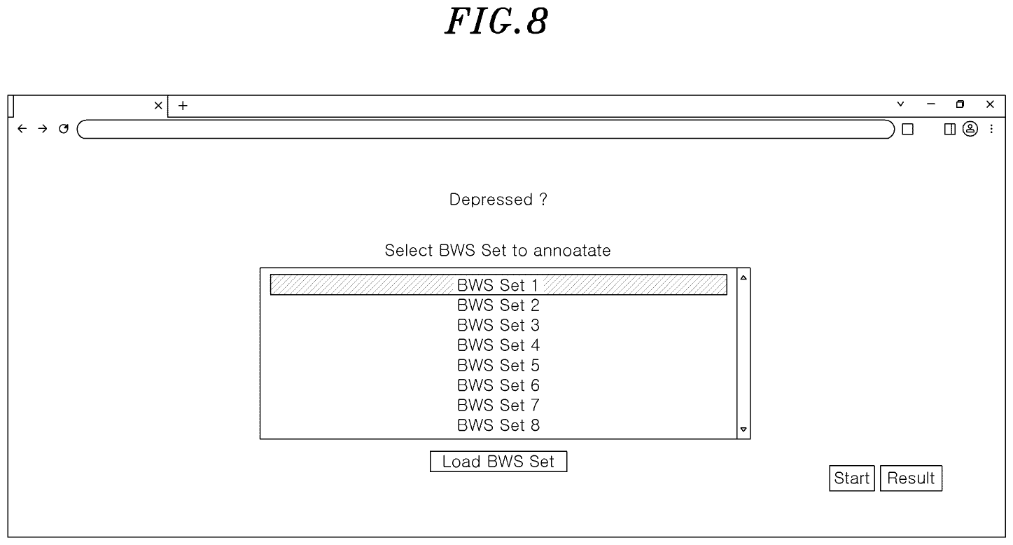

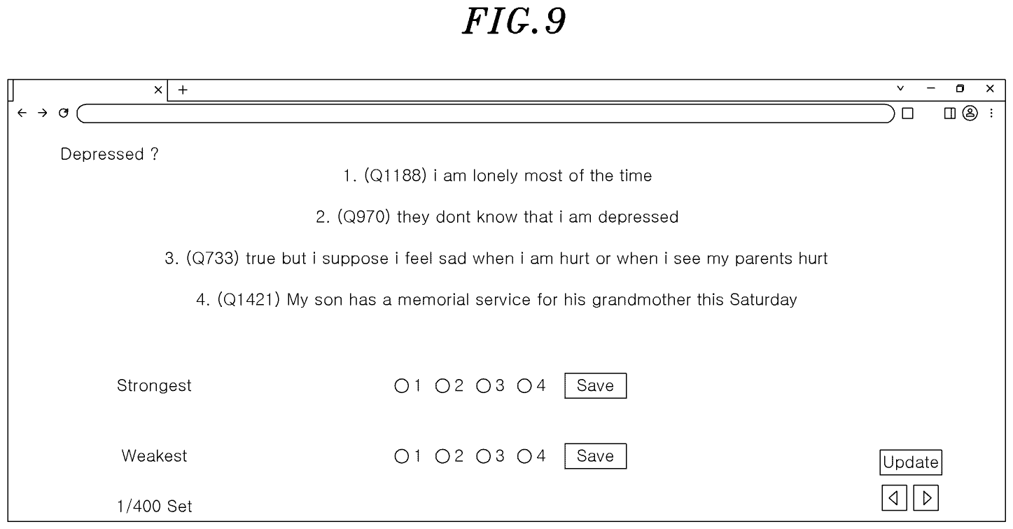

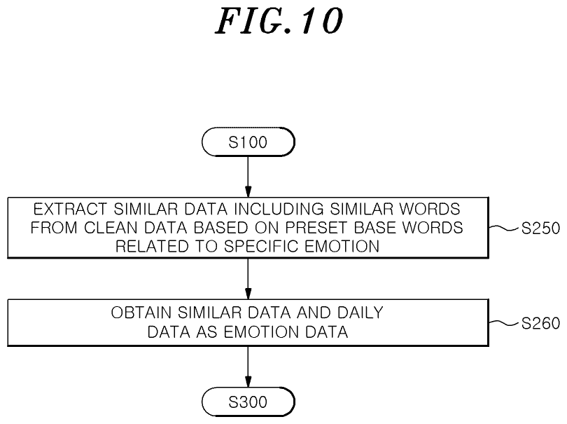

FIG. 8 and FIG. 9 are diagrams for describing the step of annotating emotion data in the language model training method according to an embodiment of the present disclosure.

FIG. 8 shows an example of a tool for best-worst scaling annotation operation.

According to one embodiment of the present disclosure, eight dataset sets may be created for annotation operation, and a set on which the annotation operation will be performed may be selected on the main screen of the tool.

At this time, each BWS set contains 400 questionnaires composed of four pieces of text.

As shown in FIG. 9, text with the highest depression intensity and text with the lowest depression intensity are selected for each questionnaire. Upon completion of annotation operation for all BWS sets, it is possible to ascertain the number of times the depression intensity is annotated as highest and the number of times the depression intensity is annotated as lowest for each of the 1,600 pieces of text.

The depression intensity score for each text may be calculated as (the number of times the depression intensity is annotated as highest—the number of times the depression intensity is annotated as lowest)/the total number of appearances (8)×100. Since scores obtained using the formula also include negative numbers, the scores are converted to positive values through linear transformation.

FIG. 10 is a flowchart showing the step of constructing the second training dataset in the language model training method according to an embodiment of the present disclosure.

Referring to FIG. 10, step S200 of constructing the second training dataset may be performed in the second training data construction module, and the second training data construction module extracts similar data containing similar words based on base words related to the specific emotion, preset in the clean data in step S250.

Thereafter, the similar data and daily data are obtained as emotion data in step S260.

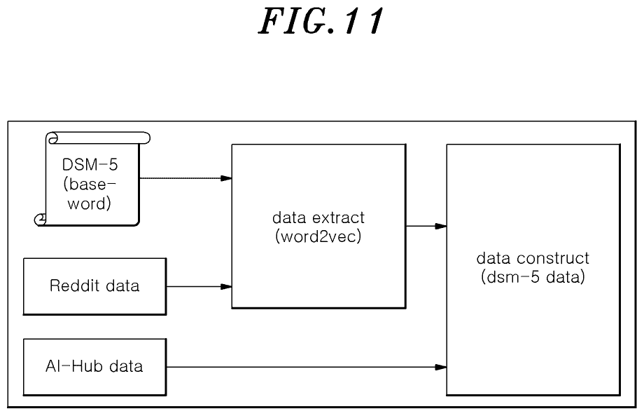

FIG. 11 is a diagram showing the second training data construction module of the language model training device according to an embodiment of the present disclosure.

Referring to FIG. 11, the second training data construction module may extract similar data containing similar words based on base words related to the specific emotion preset in the clean data and obtain the similar data and daily data as emotion data.

The process of constructing a DSM-5 dataset will be described with reference to FIG. 11.

Similar words are extracted based on base words defined with reference to Major Depressive Disorder in DSM-5, and a dataset related to Major Depressive Disorder is constructed using the base-words and similar words. AI-Hub data may also be used to label daily utterances.

Specifically, base words related to the nine symptoms for depression diagnosis in DSM-5 MDD are defined as base words. Previously collected and preprocessed Reddit data is learned using the Word2Vec model, and words (top ten) with high similarity to the defined base words are extracted. Among the extracted words, words with dictionary meanings similar to the base words are defined as similar words. Among the Reddit data, only text containing base words and similar words are extracted as similar data using a filter, and among the similar data, text that meets the MDD diagnosis criteria of DSM-5 is defined as DSM data.

The DSM data may include a total of ten labels including nine detailed symptoms related to depression and one daily label which refers to daily utterances.

In addition to utterances usually associated with depressive symptoms of MDD, users can also use daily utterances.

Accordingly, in order to classify daily utterances, subject-specific daily conversation data from AI-Hub is added to the DSM data and used for language model training.

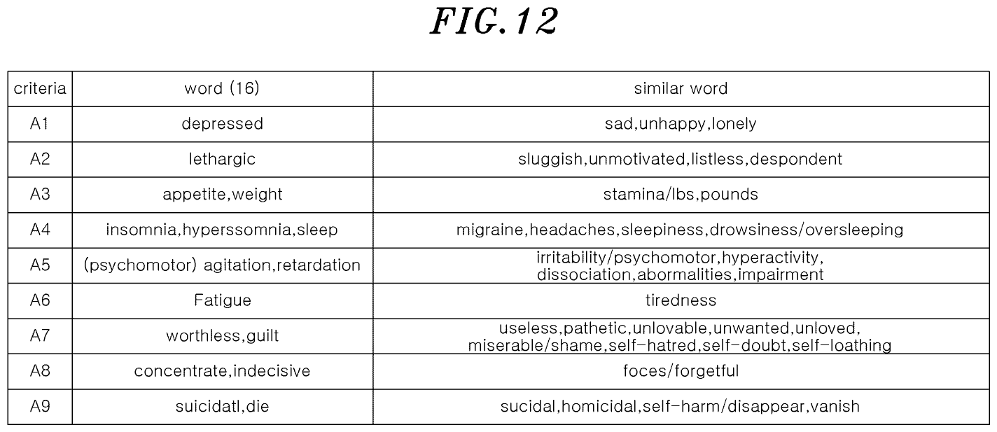

FIG. 12 to FIG. 15 are diagrams for describing DSM-5 datasets used in the language model training method according to an embodiment of the present disclosure.

Referring to FIG. 12, if at least five of the nine symptoms persist for more than 2 weeks and symptoms #1 and #2 are necessarily included in the five symptoms, the user is diagnosed as depressed. Bases words and related words are selected with reference to the criteria and related data is extracted to construct a DSM-5 dataset.

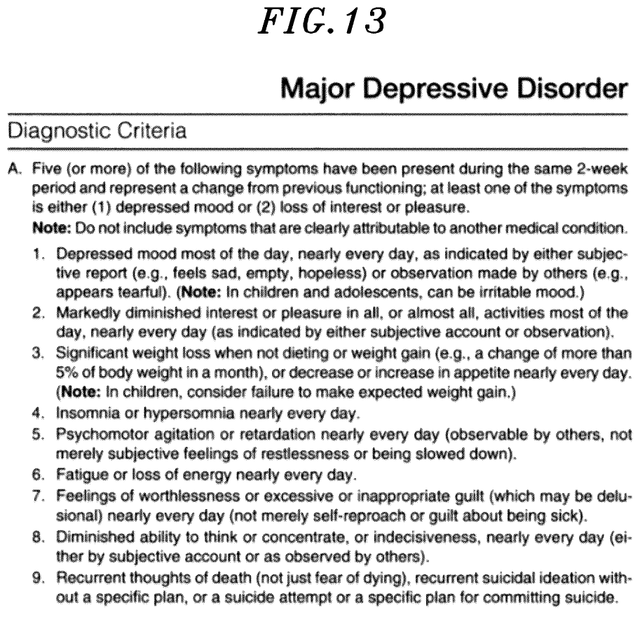

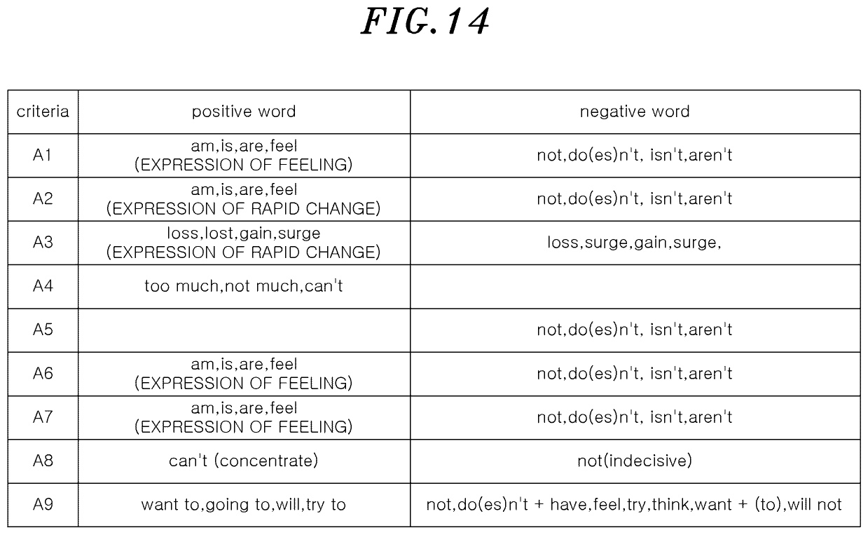

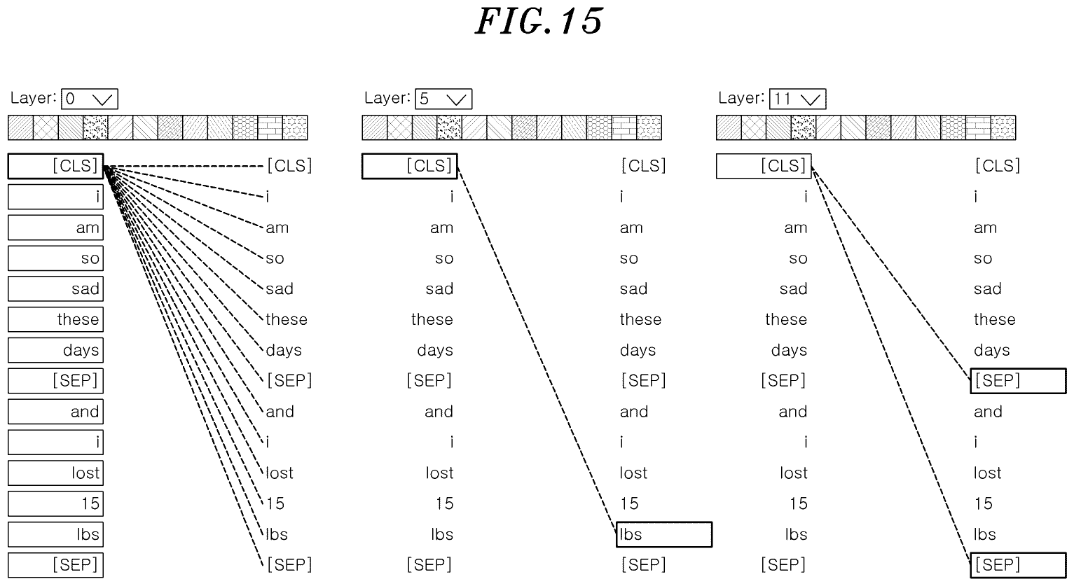

FIG. 13 shows as an example the Major Depressive Episode and depression diagnostic criteria in DSM-5 published by the American Psychiatric Association (APA).

Referring to FIG. 12 and FIG. 13, text including words is extracted, and only data related to DSM-5 is additionally extracted using positive and negative words.

As shown in FIG. 14, data containing positive word expressions is extracted first. Then, by using negative words, the data remains as it is if negative words are included therein an even number of times and is removed if negative words are included therein an odd number of times. In the case of A8 criteria, the meanings of “concentrate” and “indecisive” are conflicting.

Accordingly, only positive word filtering is applied to “concentrate” and analogs of “concentrate” to extract data including “can't”, and only negative word filtering is applied to “indecisive” and analogs of “indecisive” to remove data including “not”.

Attention information from classification results using the DSM-5 model may be visualized using the BertViz library.

For example, if attention information regarding the text “I am so sad these days [September] and I lost 15 lbs [September]” is visualized, it may appear as shown in FIG. 15.

In FIG. 15, Layer 0 visualizes information on attention heads close to the input layer of the text, and Layer 5 visualizes information on attention heads in the fifth hidden layer. The color of the line indicates an attention head present in the corresponding layer, and the thicker the line, the higher the attention score of a token.

Accordingly, it is possible to ascertain a token to which attention is paid when updating the left token.

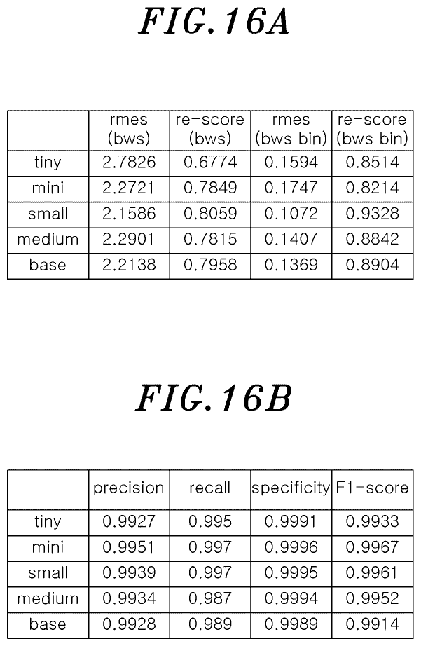

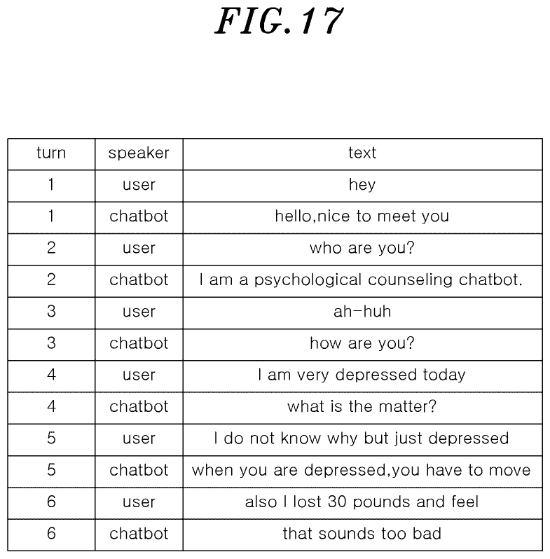

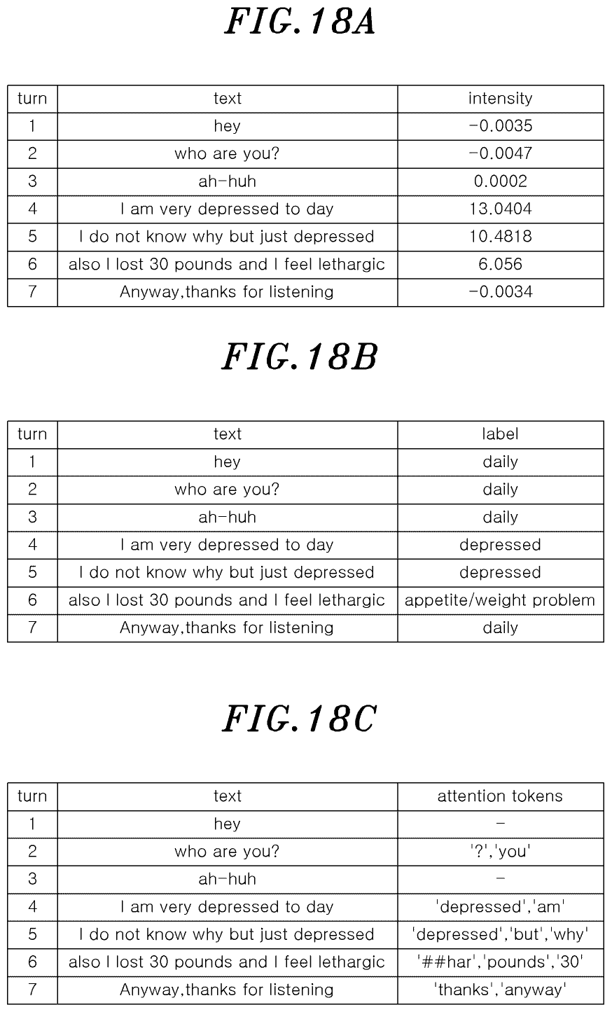

FIGS. 16A, 16B, 17, 18A, 18B, and 18C are diagrams showing examples of diagnosis results of the emotion diagnosis device according to an embodiment of the present disclosure.

As experimental data in the diagnosis results, training, validation, and division into test datasets are performed on data collected and preprocessed in the subreddit r/depression, and then model performance is analyzed using the test datasets.

The performance evaluation results for test datasets of the BWS model are shown in FIG. 16A. BWS bin is a model trained by assigning binary classification labels (depressed: 1, non-depressed: 0) instead of detailed depressive emotion intensity values to data used to construct BWS data.

The performance evaluation results for test datasets of the DSM-5 model are shown in FIG. 16B.

FIG. 17 shows an example of a virtual conversation scenario between a user and a Chatbot in order to analyze conversations using a model architecture constructed using the BERT-small and BERT-mini models at the time of classifying depression intensity and depression symptoms for user input text.

A virtual conversation is performed in the order of starting the conversation→talking about depressed feelings→talking about related symptoms→ending the conversation.

Predicting a virtual conversation about a user's utterance using the constructed model architecture is shown in FIGS. 18A, 18B, and 18C.

As shown in FIGS. 18A, 18B and 18C, three types of information, depression intensity, detailed depression-related symptoms, and focused tokens, are presented to aid users in detecting depressive symptoms early.

Combinations of steps in each flowchart attached to the present disclosure may be executed by computer program instructions. Since the computer program instructions can be mounted on a processor of a general-purpose computer, a special purpose computer, or other programmable data processing equipment, the instructions executed by the processor of the computer or other programmable data processing equipment create a means for performing the functions described in each step of the flowchart. The computer program instructions can also be stored on a computer-usable or computer-readable storage medium which can be directed to a computer or other programmable data processing equipment to implement a function in a specific manner. Accordingly, the instructions stored on the computer-usable or computer-readable recording medium can also produce an article of manufacture containing an instruction means which performs the functions described in each step of the flowchart. The computer program instructions can also be mounted on a computer or other programmable data processing equipment. Accordingly, a series of operational steps are performed on a computer or other programmable data processing equipment to create a computer-executable process, and it is also possible for instructions to perform a computer or other programmable data processing equipment to provide steps for performing the functions described in each step of the flowchart.

In addition, each step may represent a module, a segment, or a portion of codes which contains one or more executable instructions for executing the specified logical function(s). It should also be noted that in some alternative embodiments, the functions mentioned in the steps may occur out of order. For example, two steps illustrated in succession may in fact be performed substantially simultaneously, or the steps may sometimes be performed in a reverse order depending on the corresponding function.

The above description is merely exemplary description of the technical scope of the present disclosure, and it will be understood by those skilled in the art that various changes and modifications can be made without departing from original characteristics of the present disclosure. Therefore, the embodiments disclosed in the present disclosure are intended to explain, not to limit, the technical scope of the present disclosure, and the technical scope of the present disclosure is not limited by the embodiments. The protection scope of the present 10 disclosure should be interpreted based on the following claims and it should be appreciated that all technical scopes included within a range equivalent thereto are included in the protection scope of the present disclosure.

What is claimed is:

1. A method for training a language model performed by a device for training the language model, the method comprising:
receiving text data;
generating clean data by removing errors included in the received text data;
detecting emotion data related to a specific emotion from the clean data and generating a training dataset including the detected emotion data; and
training the language model using the training dataset.

2. The method of claim 1, wherein the language model includes:
a first language model for calculating an intensity of emotion with respect to the specific emotion; and
a second language model for performing detailed emotion classification with respect to the specific emotion.

3. The method of claim 1, wherein the generating clean data includes:
removing missing values from the text data; and
removing errors from the text data by performing a referential integrity check on data from which the missing values have been removed.

4. The method of claim 1, wherein the training dataset includes:
a first training dataset including a collection of overall rankings of respondents; and
a second training dataset including emotion diagnosis information.

5. The method of claim 4, wherein the generating the first training dataset includes:
extracting data including keywords related to the specific emotion from the clean data; and
obtaining data related to symptoms related to the specific emotion as emotion data from the extracted data.

6. The method of claim 9, wherein the generating the first training dataset includes extracting data including keywords and negative words related to the specific emotion from the clean data and obtaining the data as daily data.

7. The method of claim 9, further comprising, after the generating the first training dataset, matching predetermined annotation information to the emotion data based on classification conditions preset for the the first training dataset.

8. The method of claim 5, wherein the generating the second training dataset includes:
extracting similar data including similar words from the clean data based on preset base words related to the specific emotion; and
obtaining the similar data and daily data as emotion data.

9. A device for emotion diagnosis, the device comprising:
a memory configured to store a pre-trained language model and one or more instructions for executing the pre-trained language model; and
a processor configured to execute the one or more instructions stored in the memory, wherein the instructions, when executed by the processor, cause the processor to:
receive text data for diagnosing an emotion, and
output an intensity of emotion and classified detailed emotions with respect to a specific emotion from the text data using the language model,
wherein the pre-trained language model has been trained using a training dataset on emotion data related to the specific emotion.

10. The device of claim 9, wherein the pre-trained language model includes:
a first language model for calculating an intensity of emotion with respect to the specific emotion; and
a second language model for performing detailed emotion classification with respect to the specific emotion.

11. The device of claim 9, wherein the training dataset includes:
a first training dataset including a collection of overall rankings of respondents; and
a second training dataset including emotion diagnosis information.

12. A non-transitory computer readable storage medium storing computer executable instructions, wherein the instructions, when executed by a processor, cause the processor to perform a method for training language model, the method comprising:
receiving text data;
generating clean data by removing errors included in the received text data;
detecting emotion data related to a specific emotion from the clean data and generating a training dataset including the detected emotion data; and
training the language model using the training dataset.

13. The non-transitory computer readable storage medium of claim 12, wherein the language model includes:
a first language model for calculating an intensity of emotion with respect to the specific emotion; and
a second language model for performing detailed emotion classification with respect to the specific emotion.

14. The non-transitory computer readable storage medium of claim 12, wherein the generating clean data includes:
removing missing values from the text data; and
removing errors from the text data by performing a referential integrity check on data from which the missing values have been removed.

15. The non-transitory computer readable storage medium of claim 12, wherein the training dataset includes:
a first training dataset including a collection of overall rankings of respondents; and
a second training dataset including emotion diagnosis information.

16. The non-transitory computer readable storage medium of claim 15, wherein the generating the first training dataset includes:
extracting data including keywords related to the specific emotion from the clean data; and
obtaining data related to symptoms related to the specific emotion as emotion data from the extracted data.

17. The non-transitory computer readable storage medium of claim 16, wherein the generating the first training dataset includes extracting data including keywords and negative words related to the specific emotion from the clean data and obtaining the data as daily data.

18. The non-transitory computer readable storage medium of claim 16, further comprising, after the generating the first training dataset, matching predetermined annotation information to the emotion data based on classification conditions preset for the the first training dataset.

19. The non-transitory computer readable storage medium of claim 16, wherein the generating the second training dataset includes:
extracting similar data including similar words from the clean data based on preset base words related to the specific emotion; and
obtaining the similar data and daily data as emotion data.
